(19) United States
(12) Patent Application Publication
(10) Pub. No.: US 2018/0047004 A1
(43) Pub. Date: Feb. 15, 2018

(54) APPARATUS AND METHOD FOR CARRYING OUT PAYMENTS FOR NETWORKED SERVICE DEVICES

(71) Applicant: MasterCard Asia/Pacific Pte. Ltd., Sinagpore (SG)

(72) Inventors: Rajat Maheshwari, Sinagpore (SG); Vijin Venugopalan, Singapore (SG); Saadia Anwar, Singapore (SG)

(21) Appl. No.: 15/676,026

(22) Filed: Aug. 14, 2017

(30) Foreign Application Priority Data
Aug. 12, 2016 (SG) 10201606710R

(51) Int. Cl. G06Q 20/20; G06Q 20/32

(52) U.S. Cl. CPC G06Q 20/204; G06Q 20/32

(57) ABSTRACT

There is provided an apparatus and method for carrying out payments for networked service devices. Payments are able to be carried out after both the networked service devices are authenticated, and after a cost of consuming a goods/service is determined.

### FIELD OF INVENTION

The present invention relates to an apparatus and method for carrying out payments for networked service devices.

### BACKGROUND

In recent years, substantial advances have been made in the incorporation of network connectivity in devices. Consequently, the number of network connected devices is increasing significantly, and the industries using these network connected devices are diverse, such as, for example, automotive, housing, public utilities, infrastructure and so forth.

Unfortunately, the network connected devices typically do not include facilities/aspects to carry out payments, as they are limited in terms of processing power. Even though the network connected devices are able to provide users with some conveniences such as, for example, remote control of devices, remote access to data pertaining to the devices, and so forth, the convenience of carrying out payments has not been provided to the users, leading to situations when the user has to be inconvenienced in order to carry out payments in pertinent situations.

### SUMMARY

In a first aspect, there is provided a method of carrying out a payment for a networked service device. The method includes, in one or more electronic processing devices: authenticating, at a user device, the networked service device; receiving, from the networked service device, to-date goods/service consumption data at the networked service device; determining, at the user device, a goods/service consumption quantum at the networked service device; determining, at the user device, a cost for the goods/service consumption quantum; and triggering, at the user device, a transaction at a payment system to a goods/service provider.

The method can further include, in one or more electronic processing devices: receiving, from the networked service device, a notification signal to commence communications; receiving, from the networked service device, an ID of the networked service device; and receiving, from the payment system, an indication of the transaction with the goods/service provider.

Preferably, the service consumption quantum is determined from a difference of the to-date goods/service consumption data with a last-measured goods/service consumption data.

It is preferable that the notification signal is received via Bluetooth™ Low Energy (BLE), ZigBee, WiFi or NFC.

It is preferable that the cost of the goods/service consumption quantum is determined from a unit price of the goods/service. The unit price can also be determined from a comparative assessment of available sources of the goods/service.

The method can also further include, in one or more electronic processing devices: transmitting, to a server of the goods/service provider, instructions to replenish the goods/service depleted as per the consumption quantum.

In another aspect, there is provided an apparatus for carrying out a payment for a networked service device, the apparatus including one or more electronic processing devices that: authenticate the networked service device; receive, from the networked service device, to-date goods/service consumption data at the networked service device; determine a goods/service consumption quantum over a predetermined duration at the networked service device; determine a cost for the goods/service consumption quantum; and trigger a transaction at a payment system to a goods/service provider.

The apparatus can further include, in one or more electronic processing devices that: receive, from the networked service device, a notification signal to commence communications; receive, from the networked service device, an ID of the networked service device; and receive, from the payment system, an indication of the transaction with the goods/service provider.

It is preferable that the service consumption quantum is determined from a difference of the to-date goods/service consumption data with a last-measured goods/service consumption data.

Preferably, the notification signal is received via Bluetooth™ Low Energy (BLE), ZigBee, WiFi or NFC.

The cost of the goods/service consumption quantum is preferably determined from a unit price of the goods/service. The unit price can be determined from a comparative assessment of available sources of the goods/service.

The apparatus can further include, in one or more electronic processing devices that: transmit, to a server of the goods/service provider, instructions to replenish the goods/service depleted as per the consumption quantum.

In a final aspect, there is provided a non-transitory computer readable storage medium embodying thereon a program of computer readable instructions which, when executed by one or more processors of a user device in communication with at least one networked service device, and a server of a goods/service provider, cause the user device to perform a method for carrying out a payment for a networked service device, the method embodying the steps of: authenticating the networked service device; receiving, from the networked service device, to-date goods/service consumption data at the networked service device; determining a goods/service consumption quantum over a predetermined duration at the networked service device; determining a cost for the goods/service consumption quantum; and triggering a transaction at a payment system to a goods/service provider.

The storage medium can further include, in one or more electronic processing devices, the method further embodying the steps of: receiving, from the networked service device, a notification signal to commence communications; receiving, from the networked service device, an ID of the networked service device; and receiving, from the payment system, an indication of the transaction with the goods/service provider.

It is preferable that the service consumption quantum is determined from a difference of the to-date goods/service consumption data with a last-measured goods/service consumption data.

The notification signal is preferably received via Bluetooth™ Low Energy (BLE), ZigBee, WiFi or NFC.

The cost of the goods/service consumption quantum is preferably determined from a unit price of the goods/service. The unit price can be determined from a comparative assessment of available sources of the goods/service.

The storage medium can further include, in one or more electronic processing devices, the method further embodying the steps of: transmitting, to a server of the goods/service provider, instructions to replenish the goods/service depleted as per the consumption quantum.

### DESCRIPTION OF FIGURES

A non-limiting example of the present invention will now be described with reference to the accompanying drawings, in which:

FIG. 1 is a flow chart of an example of a method for carrying out payments for networked service devices;

FIG. 2 is a schematic diagram of an example of a system for carrying out payments for networked service devices;

FIG. 3 is a schematic diagram showing components of an example user device of the system shown in FIG. 2;

FIG. 4 is a schematic diagram showing components of an example payment system of the system shown in FIG. 2;

FIG. 5 is a schematic diagram showing components of an example server of the system shown in FIG. 2; and

FIG. 6 is a flowchart of a specific example of a method for carrying out payments for networked service devices.

### DETAILED DESCRIPTION

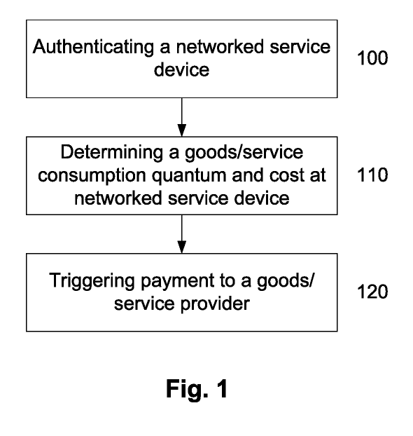

An example of a method for carrying out payments for networked service devices will now be described with reference to FIG. 1.

For the purpose of illustration, it is assumed that the method is performed at least in part using one or more electronic processing devices such as a suitably programmed microcontroller forming part of a user device, such as mobile phones, portable computers, tablet computers, or the like. The user device is also typically in communication with a payment system which may comprise any suitable computer system such as a server that is capable of processing payments made by the user and which may include a number of processing devices associated with each of an issuer, acquirer, card network and payment gateway, or alternatively, the payment processing system may include any one or more of these entities and this will be discussed further below.

The term service device is intended to cover any electrical device that consumes power and will typically refer to appliances such as, for example, electricity meters, fridges, television content devices, wine coolers, air conditioners, industrial machines and the like. Service devices may also include devices which measure consumption of a resource, such as water meters.

In this example, at step 100, authentication is carried out for a networked service device at a user device. Positive authentication of the networked service device enables authorised communications to take place between the networked service device and the user device. Authorised communications can include, for example, obtaining consumption data from the networked service device, obtaining identification data from the networked service device, and so forth. Positive authentication occurs when the networked service device, for example, is able to be associated with a user of the user device, for instance, when an ID of the user is cross-referenced with a serial number of the networked service device such that the user of the user device is an authorised user of the networked service device.

Typically, the one or more networked service devices communicate with the user device via a wireless communications protocol such as Bluetooth, ZigBee, Wi-fi and the like. In one example, the networked service device includes a wireless transceiver such as a Bluetooth™ Low Energy (BLE) module. In one example, the networked service device is configured to provide a wireless hotspot to which the user device may be connected or paired when the user device comes within a certain vicinity of the networked service device in order to establish communication therewith.

At step 110, the user device then determines a goods/service consumption quantum at a networked service device. This can be determined by obtaining a difference of a to-date goods/service consumption data with a last-measured goods/service consumption data. The last-measured goods/service consumption data can be either stored locally on the user device, or it can be retrieved from an external repository storing records of goods/service consumption data. It should be appreciated that the last-measured goods/service consumption data need not be retrieved at an identical user device. For instance, in an example when the networked service device is an electricity meter, the to-date goods/service consumption data is an in-situ reading of electricity consumption, while the last-measured goods/service consumption data is the in-situ reading of electricity consumption at a juncture when the electricity meter last communicated with the user device. In another example, when the networked service device is a fridge, the to-date goods/service consumption data is an in-situ stock level of canned drinks, while the last-measured goods/service consumption data is the in-situ stock level of canned drinks at a juncture when the fridge last communicated with the user device.

Subsequently, a cost for the goods/service consumed is determined depending on a unit price of the goods/service. For example, the unit price can be for a 1 KWHr of electricity, a cost for a canned drink, a cost for a bottle of wine, and so forth. The unit price can also be determined from a comparative assessment of available sources of the goods/service.

At step 120, the user device then triggers payment for the goods/service consumption quantum, the payment being to a goods/service provider. It should be appreciated that the payment can be for goods/service which has been consumed (post-paid), or yet to be consumed (pre-paid). For example, the triggering of payment may cause a user interface such as payment webpage, or a user interface screen of a mobile application, to be displayed on the user device which provides a representation of the payment cost. The user then selects a desired payment option for example by clicking on a button indicative of the payment option and proceeds to checkout to pay for the goods/service. In this way, the user provides payment information to the payment system in accordance with the payment option selected by the user. The transaction may then be processed in a similar way to which a standard ecommerce transaction is performed. In response to successful payment to the goods/service provider, the user device then receives an indication of the successful payment made to the goods/service provider (an acknowledgement or receipt).

The above described method provides a number of advantages.

It should be appreciated that the method enables users to be able to pay for goods/service from a networked service device using the user device in a manner which does not require the goods/service provider to physically verify the networked service device, or which reduces the frequency with which the goods/service provider needs to conduct audits of usage of the networked service device. In addition, the payment can be carried out either pre-paid or post-paid, which can depend on the nature of the goods/service or a preference of the user.

In addition, the method can also enable users to analyse consumption patterns for goods/service from a networked service device. By analysing consumption patterns, it can be possible for the users to understand their consumption habits and possibly change or predict their consumption habits.

Furthermore, the method can also enable ‘pay per use’ functionality for instance, for electricity, contents in a fridge, contents in a wine cooler, and so forth. Thus, it can be possible for users of the networked service device to reduce their costs from having networked service devices where payment to goods/service providers can be made by third parties via use of a user device. Moreover, the ‘pay per use’ functionality may assist in reducing energy usage by encouraging users to become more conscious of the amount of electricity that they use, particularly when they learn to correlate use of electricity with a specific cost.

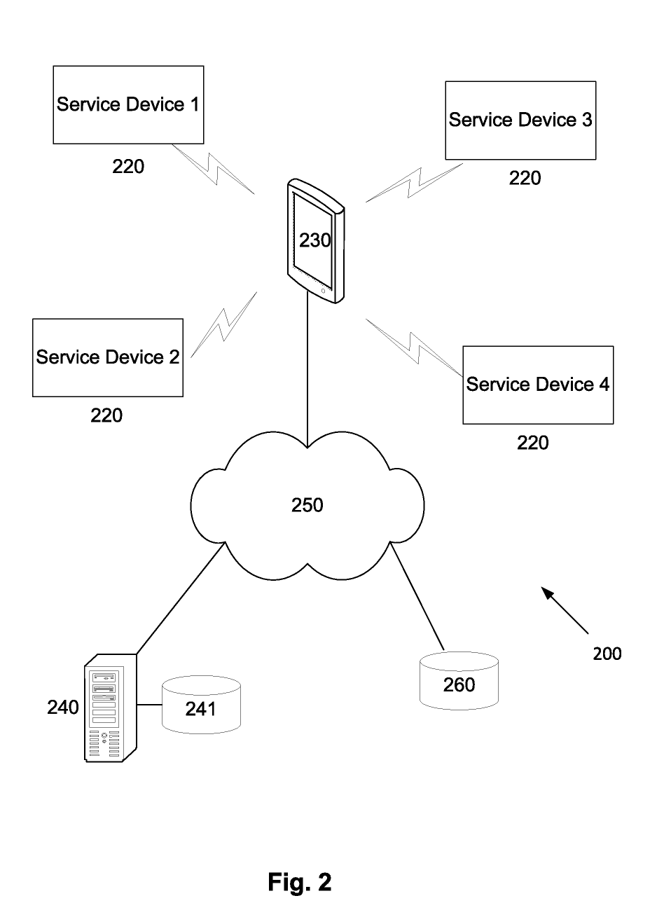

An example of a system for carrying out payments for networked service devices will now be described with reference to FIG. 2.

In this example, the system 200 includes a plurality of service devices 220 in communication with a user device 230. The user device 230 is in communication with a payment system 240, and a server 260 of a goods/service provider via a communications network 250. The payment system 240 may be in communication with a database 241. The plurality of service devices 220 is also in communication with the communications network 250, although this is not depicted in FIG. 2.

The communications network 250 can be of any appropriate form, such as the Internet and/or a number of local area networks (LANs). It will be appreciated that the configuration shown in FIG. 2 is for the purpose of example only, and in practice the user device 230, service devices 220, server 260 and payment system 240 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like. Typically, the user device 230 communicates with the service device 220 via a wireless communication protocol such as Bluetooth, Wi-Fi Zigbee, or through Near Field Communication (NFC) but not limited to such.

### User Device 230

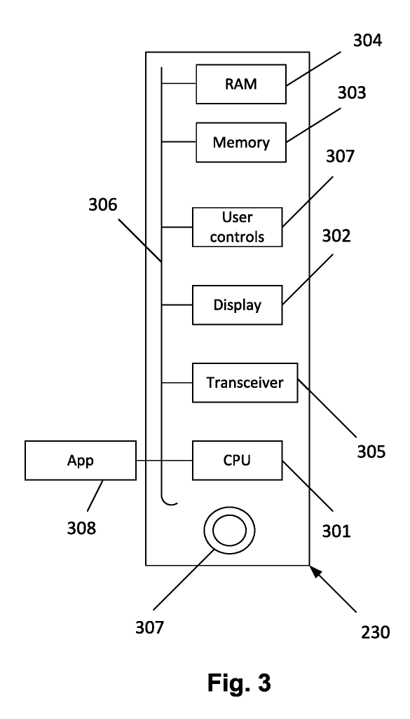

The user device 230 of any of the examples herein may be a handheld computer device such as a smart phone or a PDA such as one manufactured by Apple™, LG™, HTC™, Blackberry™, or Motorola™. The user device 230 may include a mobile computer such as a tablet computer. An exemplary embodiment of a user device 230 is shown in FIG. 3. As shown, the device 230 includes the following components in electronic communication via a bus 306:

1. a display 302;

2. non-volatile memory 303;

3. random access memory (“RAM”) 304;

4. N processing components 301;

5. a transceiver component 305 that includes N transceivers; and

6. user controls 307.

Although the components depicted in FIG. 3 represent physical components, FIG. 3 is not intended to be a hardware diagram; thus many of the components depicted in FIG. 3 may be realized by common constructs or distributed among additional physical components. Moreover, it is certainly contemplated that other existing and yet-to-be developed physical components and architectures may be utilized to implement the functional components described with reference to FIG. 3.

The display 302 generally operates to provide a presentation of content to a user, and may be realized by any of a variety of displays (e.g., CRT, LCD, HDMI, micro-projector and OLED displays). And in general, the non-volatile memory 303 functions to store (e.g., persistently store) data and executable code including code that is associated with the functional components of a browser component and applications, and in one example, a payment application 308 executing on the user device 230. In some embodiments, for example, the non-volatile memory 303 includes bootloader code, modem software, operating system code, file system code, and code to facilitate the implementation of one or more portions of the payment application 308 as well as other components well known to those of ordinary skill in the art that are not depicted for simplicity.

In many implementations, the non-volatile memory 303 is realized by flash memory (e.g., NAND or ONENAND memory), but it is certainly contemplated that other memory types may be utilized as well. Although it may be possible to execute the code from the non-volatile memory 303, the executable code in the non-volatile memory 303 is typically loaded into RAM 304 and executed by one or more of the N processing components 301.

The N processing components 301 in connection with RAM 304 generally operate to execute the instructions stored in non-volatile memory 303 to effectuate the functional components. As one of ordinarily skill in the art will appreciate, the N processing components 301 may include a video processor, modem processor, DSP, graphics processing unit (GPU), and other processing components.

The transceiver component 305 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

### Service Device 220

A suitable service device 220 for use in the system 200 for carrying out payments for networked service devices described in any one of the above examples is shown in FIG. 2.

Generally, the service device 220 includes any electrical device that consumes power and will typically refer to appliances such as, for example, electricity meters, fridges, television content devices, wine coolers, industrial machines and the like.

### Payment System 240

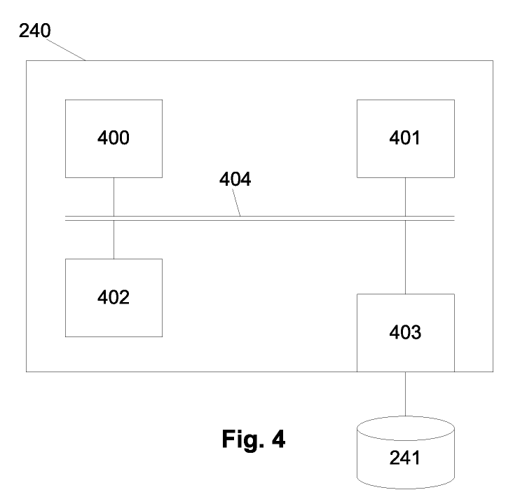

A suitable payment system 240 for use in the system 200 described in any one of the above examples is shown in FIG. 4.

In this example, the payment system 240 is a server that includes at least one microprocessor 400, a memory 401, an optional input/output device 402, such as a display, keyboard, touchscreen and the like, and an external interface 403, interconnected via a bus 404 as shown. In this example the external interface 403 can be utilised for connecting the payment server 410 to peripheral devices, such as user device 230, the communication networks 250, databases 241, other storage devices, or the like. Although a single external interface 403 is shown, this is for the purpose of example only, and in practice multiple interfaces using various methods (e.g. Ethernet, serial, USB, wireless or the like) may be provided.

In use, the microprocessor 400 executes instructions in the form of applications software stored in the memory 401 to allow communication with the user device 230, for example to provide payment options. The applications software may include one or more software modules, and may be executed in a suitable execution environment, such as an operating system environment, or the like.

Accordingly, it will be appreciated that the payment system 240 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. Thus, in one example, the processing system 400 is a standard processing system such as an Intel Architecture based processing system, which executes software applications stored on non-volatile (e.g., hard disk) storage, although this is not essential.

In other examples, such as described above, the payment system is formed of multiple computer systems interacting, for example, via a distributed network arrangement. As distributed networking is known in the art, it will not be described further in more detail.

In particular, the payment system may include or be in communication with a number of processing systems associated with each of an issuer, acquirer, card network and payment gateway, or alternatively, the payment system may be any one or more of these entities.

In one example as will be well understood in the art, the payment system sends the user account information and payment information to the merchant's acquirer. The acquirer then requests that the card network get an authorization from the user's issuing bank. The card network submits the transaction to the issuer for authorization and the issuing bank then authorizes the transaction if the account has sufficient funds to cover the amount payable. The issuer then routes payment to the acquirer who then deposits the payment into the merchant's account.

### Goods/Service Provider Server 260

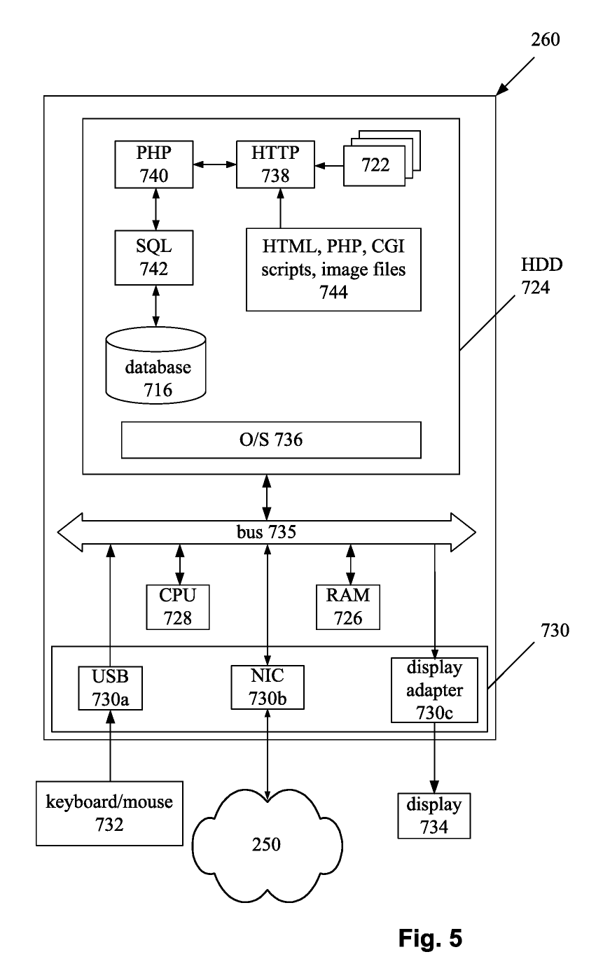

An example of the server 260 is as shown in FIG. 5. As described in a preceding section, the server 260 is able to communicate with other components of the system 200 over the wireless communications network 250 using standard communication protocols.

The components of the server 260 can be configured in a variety of ways. The components can be implemented entirely by software to be executed on standard computer server hardware, which may comprise one hardware unit or different computer hardware units distributed over various locations, some of which may require the communications network 250 for communication. A number of the components or parts thereof may also be implemented by application specific integrated circuits (ASICs) or field programmable gate arrays.

In the example shown in FIG. 5, the server 260 is a commercially available server computer system based on a 32 bit or a 64 bit Intel architecture, and the processes and/or methods executed or performed by the server 260 are implemented in the form of programming instructions of one or more software components or modules 722 stored on non-volatile (e.g., hard disk) computer-readable storage 724 associated with the server 260. At least parts of the software modules 722 could alternatively be implemented as one or more dedicated hardware components, such as application-specific integrated circuits (ASICs) and/or field programmable gate arrays (FPGAs).

The server 260 includes at least one or more of the following standard, commercially available, computer components, all interconnected by a bus 735:

1. random access memory (RAM) 726;

2. at least one computer processor 728, and

3. external computer interfaces 730:
a. universal serial bus (USB) interfaces 730a (at least one of which is connected to one or more user-interface devices, such as a keyboard, a pointing device (e.g., a mouse 732 or touchpad),
b. a network interface connector (NIC) 730b which connects the computer system 700 to a data communications network, such as the wireless communications network 250; and
c. a display adapter 730c, which is connected to a display device 734 such as a liquid-crystal display (LCD) panel device.

The server 260 includes a plurality of standard software modules, including:
1. an operating system (OS) 736 (e.g., Linux or Microsoft Windows);
2. web server software 738 (e.g., Apache, available at http://www.apache.org);
3. scripting language modules 740 (e.g., personal home page or PHP, available at http://www.php.net, or Microsoft ASP); and
4. structured query language (SQL) modules 742 (e.g., MySQL, available from http://www.mysql.com), which allow data to be stored in and retrieved/accessed from an SQL database 716.

Together, the web server 738, scripting language 740, and SQL modules 742 provide the server 260 with the general ability to allow the other components of the system 200 to communicate with the server 260 and in particular to provide data to and receive data from the database 716. It will be understood by those skilled in the art that the specific functionality provided by the server 260 to such users is provided by scripts accessible by the web server 738, including the one or more software modules 722 implementing the processes performed by the server 260, and also any other scripts and supporting data 744, including markup language (e.g., HTML, XML) scripts, PHP (or ASP), and/or CGI scripts, image files, style sheets, and the like.

The boundaries between the modules and components in the software modules 722 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the server 260 may be executed by a module (of software modules 722) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The server 260 normally processes information according to a program (a list of internally stored instructions such as a particular application program and/or an operating system) and produces resultant output information via input/output (I/O) devices 730. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

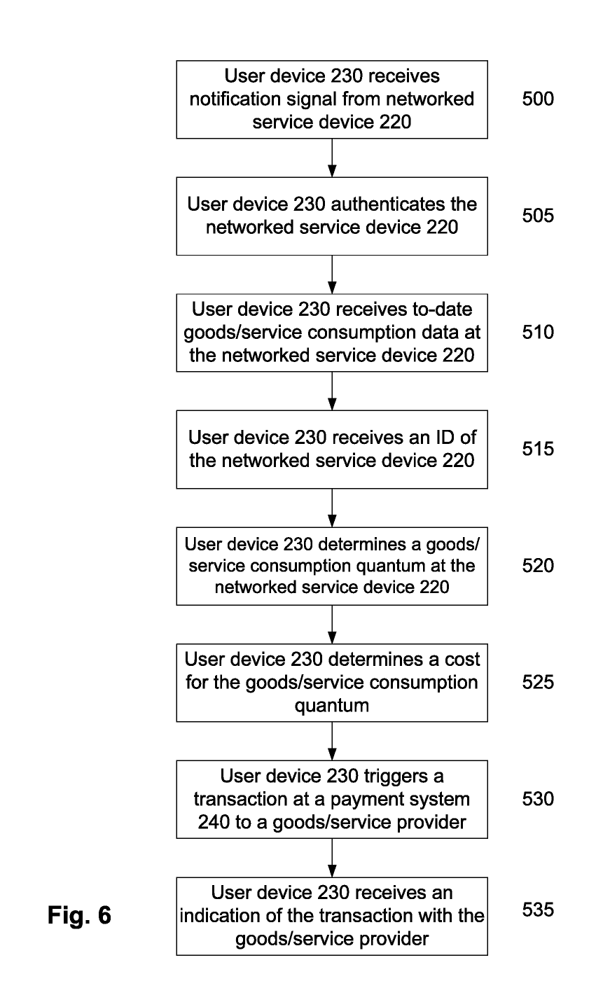

To illustrate further features of preferred practical implementations of the method, a further detailed example of a method for carrying out payments for networked service devices will now be described with reference to FIG. 6.

At step 500, the user device 230 receives a notification signal from the networked service device 220. Their user device 230 then pairs to the networked service device 220, for example through Bluetooth connectivity, Zigbee, Wi-Fi or any other suitable wireless communications protocol. In one example, the networked service device 220 includes a wireless transceiver such as a Bluetooth™ Low Energy (BLE) module. In one example, the networked service device 220 is configured to provide a wireless hotspot to which the user device 230 may be connected or paired when the user device 230 comes within a certain vicinity of the networked service device 220 in order to establish communication therewith.

Once a connection has been established, the user device 230 then authenticates the networked service device 220 at step 505. Positive authentication of the networked service device 220 enables authorised communications to take place between the networked service device 220 and the user device 230. Authorised communications can include, for example, obtaining consumption data from the networked service device 220, obtaining identification data from the networked service device 220, and so forth. Positive authentication occurs when the networked service device 220, for example, is able to be associated with a user of the user device 230, for instance, when an ID of the user is cross-referenced with a serial number of the networked service device 220 such that the user of the user device 230 is an authorised user of the networked service device 220.

The user device 230 then receives to-date goods/service consumption data at the networked service device 220 at step 510, and an ID of the networked service device 220 at step 515.

At step 520, the user device 230 determines a goods/service consumption quantum at the networked service device 220, and a cost of the goods/service consumption quantum at step 525. This can be determined by obtaining a difference of a to-date goods/service consumption data with a last-measured goods/service consumption data. The last-measured goods/service consumption data can be either stored locally on the user device 230, or it can be retrieved from an external repository storing records of goods/service consumption data. It should be appreciated that the last-measured goods/service consumption data need not be retrieved at an identical user device 230. For instance, in an example when the networked service device 220 is an electricity meter, the to-date goods/service consumption data is an in-situ reading of electricity consumption, while the last-measured goods/service consumption data is the in-situ reading of electricity consumption at a juncture when the electricity meter last communicated with a user device 230. In another example, when the networked service device 220 is a fridge, the to-date goods/service consumption data is an in-situ stock level of canned drinks, while the last-measured goods/service consumption data is the in-situ stock level of canned drinks at a juncture when the fridge last communicated with a user device 230. Subsequently, a cost for the goods/service consumed is determined depending on a unit price of the goods/service. For example, the unit price can be for a 1 KWHr of electricity, a cost for a canned drink, a cost for a bottle of wine, and so forth. The unit price can also be determined from a comparative assessment of available sources of the goods/service.

Subsequently, at step 530, the user device 230 triggers a transaction at a payment system 240 to a goods/service provider. The payment can be for goods/service which have been consumed (post-paid), or yet to be consumed (pre-paid). For example, the triggering of payment may cause a user interface such as payment webpage to be displayed on the user device 230 which provides a representation of the payment cost. The user then selects a desired payment option for example by clicking on a button indicative of the payment option and proceeds to checkout to pay for the goods/service. In this way, the user provides payment information to the payment system 240 in accordance with the payment option selected by the user. The transaction may then be processed in a similar way to which a standard ecommerce transaction is performed. In response to successful payment to the goods/service provider, the user device 230 then receives an indication of the successful payment made to the goods/service provider (an acknowledgement or receipt) at step 535.

Finally, it is also possible that the user device 230 transmits instructions to a server 260 of the goods/service provider to replenish the goods/service depleted as per the consumption quantum. This can be a step which provides the user with a convenience of not having to keep track of availability of the goods/service as the user can expect replenishment of the goods/service.

Accordingly, it will be appreciated that in at least one example the above described methods and system may enable users to be able to pay for goods/service from a networked service device 220 using the user device 230 in a manner which does not require the goods/service provider to physically verify the networked service device 230. In addition, the payment can be carried out either pre-paid or post-paid, which can depend on the nature of the goods/service or a preference of the user.

In addition, the methods and system can also enable users to analyse consumption patterns for goods/service from a networked service device 220. By analysing consumption patterns, it can be possible for the users to understand their consumption habits and possibly change or predict their consumption habits.

Furthermore, the methods and system can also enable ‘pay per use’ functionality for instance, for electricity, contents in a fridge, contents in a wine cooler, and so forth. Thus, it can be possible for users of the networked service device 220 to reduce their costs from having networked service devices 220 where payment to goods/service providers can be made by third parties via use of a user device 230. Moreover, the ‘pay per use’ functionality may assist in reducing energy usage by encouraging users to become more conscious of the amount of electricity that they use, particularly when they learn to correlate use of electricity with a specific cost.

Persons skilled in the art will appreciate that numerous variations and modifications will become apparent. All such variations and modifications which become apparent to persons skilled in the art, should be considered to fall within the spirit and scope that the invention broadly appearing before described.

1. A computer-implemented method of carrying out a payment for a networked service device, the method including, in one or more electronic processing devices:
authenticating, at a user device, the networked service device;
receiving, from the networked service device, to-date goods/service consumption data at the networked service device;
determining, at the user device, a goods/service consumption quantum at the networked service device;
determining, at the user device, a cost for the goods/service consumption quantum; and
triggering, at the user device, a transaction at a payment system to a goods/service provider.

2. The computer-implemented method of claim 1, further including, in one or more electronic processing devices:
receiving, from the networked service device, a notification signal to commence communications;
receiving, from the networked service device, an ID of the networked service device; and
receiving, from the payment system, an indication of the transaction with the goods/service provider.

3. The computer-implemented method of claim 1, wherein the service consumption quantum is determined from a difference of the to-date goods/service consumption data with a last-measured goods/service consumption data.

4. The computer-implemented method of claim 1, wherein the notification signal is received via Bluetooth™ Low Energy (BLE), ZigBee, WiFi or NFC.

5. The computer-implemented method of claim 1, wherein the cost of the goods/service consumption quantum is determined from a unit price of the goods/service, the unit price being determined from a comparative assessment of available sources of the goods/service.

6. The computer-implemented method of claim 1, further including, in one or more electronic processing devices:
transmitting, to a server of the goods/service provider, instructions to replenish the goods/service depleted as per the consumption quantum.

7. An apparatus for carrying out a payment for a networked service device, the apparatus including one or more electronic processing devices that:
authenticate the networked service device;
receive, from the networked service device, to-date goods/service consumption data at the networked service device;
determine a goods/service consumption quantum over a predetermined duration at the networked service device;
determine a cost for the goods/service consumption quantum; and
trigger a transaction at a payment system to a goods/service provider.

8. The apparatus of claim 7, further including, in one or more electronic processing devices that:
receive, from the networked service device, a notification signal to commence communications;
receive, from the networked service device, an ID of the networked service device; and
receive, from the payment system, an indication of the transaction with the goods/service provider.

9. The apparatus of claim 7, wherein the service consumption quantum is determined from a difference of the to-date goods/service consumption data with a last-measured goods/service consumption data.

10. The apparatus of claim 7, wherein the notification signal is received via Bluetooth™ Low Energy (BLE), ZigBee, WiFi or NFC.

11. The apparatus of claim 7, wherein the cost of the goods/service consumption quantum is determined from a unit price of the goods/service, the unit price being determined from a comparative assessment of available sources of the goods/service.

12. The apparatus of claim 8, further including, in one or more electronic processing devices that:
transmit, to a server of the goods/service provider, instructions to replenish the goods/service depleted as per the consumption quantum.

13. A non-transitory computer readable storage medium embodying thereon a program of computer readable instructions which, when executed by one or more processors of a user device in communication with at least one networked service device, and a server of a goods/service provider, cause the user device to perform a method for carrying out a payment for a networked service device, the method embodying the steps of:
authenticating the networked service device;
receiving, from the networked service device, to-date goods/service consumption data at the networked service device;
determining a goods/service consumption quantum over a predetermined duration at the networked service device;
determining a cost for the goods/service consumption quantum; and
triggering a transaction at a payment system to a goods/service provider.

14. The storage medium of claim 13, further including, in one or more electronic processing devices, the method further embodying the steps of:
receiving, from the networked service device, a notification signal to commence communications;
receiving, from the networked service device, an ID of the networked service device; and
receiving, from the payment system, an indication of the transaction with the goods/service provider.

15. The storage medium of claim 13, wherein the service consumption quantum is determined from a difference of the to-date goods/service consumption data with a last-measured goods/service consumption data.

16. The storage medium of claim 13, wherein the notification signal is received via Bluetooth™ Low Energy (BLE), ZigBee, WiFi or NFC.

17. The storage medium of claim 13, wherein the cost of the goods/service consumption quantum is determined from a unit price of the goods/service, the unit price being determined from a comparative assessment of available sources of the goods/service.

18. The storage medium of claim 13, further including, in one or more electronic processing devices, the method further embodying the steps of:
transmitting, to a server of the goods/service provider, instructions to replenish the goods/service depleted as per the consumption quantum.
